(19) United States
(12) Patent Application Publication
(10) Pub. No.: US 2020/0012602 A1
(43) Pub. Date: Jan. 9, 2020

(54) CACHE ALLOCATION METHOD, AND APPARATUS

(71) Applicant: HUAWEI TECHNOLOGIES CO., LTD., Shenzhen (CN)

(72) Inventors: Qingwei ZHAO, Shenzhen (CN); Chong GU, Shenzhen (CN)

(73) Assignee: HUAWEI TECHNOLOGIES CO., LTD., Shenzhen (CN)

(21) Appl. No.: 16/566,431

(22) Filed: Sep. 10, 2019

Related U.S. Application Data
(63) Continuation of application No. PCT/CN2018/073851, filed on Jan. 23, 2018.

(30) Foreign Application Priority Data
Mar. 17, 2017 (CN) 201710161725.2

(51) Int. Cl. G06F 12/0846; G06F 12/0895; G06F 12/084; G06F 3/06; G06F 17/11

(52) U.S. Cl. CPC G06F 12/0848; G06F 12/0895; G06F 12/084; G06F 2212/1021; G06F 3/0679; G06F 17/11; G06F 3/0607; G06F 3/0644

(57) ABSTRACT

A cache allocation method and an apparatus are applied to software as a service (SaaS) that serves at least two tenants. The at least two tenants include a target tenant, and a cache partition of the target tenant is a target cache partition. The method includes: obtaining a first cache size and a monitoring record of the target tenant, where the monitoring record includes a correspondence between an adjustment size and a cache benefit change, and the first cache size is a current cache size of the target cache partition; and analyzing the monitoring record, and adjusting the first cache size to a second cache size when determining that adjustment of the first cache size to the second cache size meets a cache benefit target. According to the method, a higher cache benefit can be obtained, and a cache sharing utilization rate is correspondingly increased.

### CROSS-REFERENCE TO RELATED APPLICATIONS

This application is a continuation of International Application No. PCT/CN2018/073851, filed on Jan. 23, 2018, which claims priority to Chinese Patent Application No. 201710161725.2, filed on Mar. 17, 2017, the disclosures of the aforementioned applications are hereby incorporated by reference in their entireties.

### TECHNICAL FIELD

Aspects of this application relate to the field of computer technologies, and in particular, to a cache allocation method and an apparatus.

### BACKGROUND

A cache (Cache) is a buffer for data exchange. When there is a data read requirement, required data is first queried from the cache. If the required data is found, the required data may be directly read. If the required data is not found, the required data is queried for from a memory. If the required data is not found in the memory, the required data is queried for from a hard disk or another larger storage device. Therefore, the cache runs fastest and runs much faster than the memory, and the cache is used to increase a device running speed.

It can be learned from the foregoing description that a larger probability of finding data in the cache indicates a higher speed of the cache. In other words, a higher cache hit ratio indicates a higher speed. The cache hit ratio is a ratio of a quantity of cache queries with non-empty query results to a total quantity of cache queries. For example, if the cache is queried 100 times, and data is found in the cache 30 times, the cache hit ratio is 30/100 =30%. Generally, if cache space is larger, more data is stored, and therefore, the cache hit ratio is higher. However, the cache space is limited, especially when there are a plurality of users. For example, in an application scenario of software as a service (Software as a Service, SaaS), a cache resource that can be allocated to each tenant is much more limited. In the SaaS, one tenant may include a plurality of users. For example, the tenant may be an enterprise, and the users are employees of the enterprise.

With rapid development of network technologies, an on-demand leasing mode of the SaaS has grown rapidly in the field of cloud computing. The SaaS provides software leasing services to a plurality of enterprise customers based on a multi-tenant technology architecture, so that a large quantity of tenants/enterprises can share software and hardware resources of a same stack, and a utilization rate of the shared resources is maximized.

An objective of a multi-tenant sharing architecture is to implement both resource sharing and proper separation between a plurality of tenants, and obtain a maximum benefit from resources. The cache is an important and limited resource to improve system performance. In a conventional cache use process, tenants are not distinguished from each other, and under an architecture in which a plurality of tenants share and contend for a cache resource, the following problems are caused:

Because of resource contention, a tenant frequently accessing a system uses more cache resources, and a tenant infrequently accessing the system uses only a few cache resources, or even has no cache resource for use. If a cache resource is extremely limited, quality of service violates a service level agreement (Service Level Agreement, SLA). Consequently, a service provider suffers a penalty and bears a financial loss. The SLA is a service level agreement signed between a tenant and an SaaS provider.

To resolve the foregoing and/or other problems, the following solution is provided: Caches of various applications are separated and allocated by using a dynamic cache partition (Dynamic Cache Partition, DCP) technology, and a specific implementation of separating and allocating the caches is as follows: a minimum value, a target value, and a maximum value are assigned to a cache of each target application. When the target application is enabled, the cache has the minimum value. A cache requirement grows in a running process of the target application. If the cache requirement continues to grow after the target value assigned to the cache of the target application is reached, a part of a cache of another application needs to be separated from the cache and allocated to the target application according to a specific rule, and a new cache is no longer allocated to the target application when the cache of the target application reaches the maximum value.

It has been proved in practice that in the foregoing solution using the DCP technology, some applications have low cache utilization rates, while other applications have poor quality of service due to lack of caches. Consequently, cache sharing utilization efficiency is relatively low.

### SUMMARY

A technical problem to be resolved in embodiments of this application is to provide a cache allocation method and an apparatus, to increase a cache sharing utilization rate.

According to a first aspect, an embodiment of this application provides a cache allocation method, where the cache allocation method is applied to software as a service SaaS that serves at least two tenants, the at least two tenants include a target tenant, a cache partition of the target tenant is a target cache partition, and the method includes:

obtaining a first cache size and a monitoring record of the target tenant, where the monitoring record includes a correspondence between an adjustment size and a cache benefit change, and the first cache size is a current cache size of the target cache partition; and

analyzing the monitoring record, and adjusting the first cache size to a second cache size when determining that adjustment of the first cache size to the second cache size meets a cache benefit target.

Usually, the tenant may be an enterprise user, and the tenant may have many users, such as enterprise employees. Each tenant may have a cache partition, and the cache partition may have an initial cache size. Then, the cache size of the tenant is adjusted when a user of the tenant uses the SaaS. It may be understood that the cache size of the cache partition is adjusted to obtain a cache benefit. The cache benefit target may be improving system performance corresponding to a cache, or may be reducing a loss caused by low system performance. The system performance corresponding to the cache may include an average cache read response time of the users of the tenant, a cache hit ratio, and the like. The loss caused by the low system performance may include a penalty loss caused by the low system performance and the like,

The monitoring record records information about the correspondence between an adjustment size and a cache benefit change. The adjustment size indicates an adjusted cache size of the cache partition. The adjustment size herein may indicate an increase or a decrease of the cache size. The increase and the decrease of the cache size may be respectively corresponding to a positive value and a negative value of the adjustment size. Alternatively, an absolute value may be used to record an adjusted size of a cache, and then whether a cache benefit is a positive benefit or a negative benefit is recorded. The cache benefit corresponds to the cache benefit target, and details are not described herein.

In addition, because the first cache size is adjusted to the second cache size, an adjustment size is a difference between the second cache size and the first cache size. The difference may be marked with a symbol to indicate an increase or a decrease of the cache size. It may be understood that if the second cache size is greater than the first cache size, a new cache is allocated to the target cache partition, or if the second cache size is less than the first cache size, a part of a cache is released from the target cache partition.

In an optional implementation, the adjusting the first cache size to a second cache size when determining that adjustment of the first cache size to the second cache size meets a cache benefit target includes:

allocating a cache of the adjustment size from an idle shared cache to the target cache partition when a first cache benefit change is greater than a second cache benefit change and a cache size of the idle shared cache is greater than the adjustment size, where the first cache benefit change corresponds to the target cache partition, and the second cache benefit change corresponds to a cache partition of all the other tenants in the at least two tenants; or

releasing a cache from the target cache partition when a third cache benefit change is less than a fourth cache benefit change and a cache size of the idle shared cache is less than the adjustment size, where the third cache benefit change corresponds to the target cache partition, and the fourth cache benefit change corresponds to a cache partition of all the other tenants in the at least two tenants.

In this embodiment, the idle shared cache is a cache that has not been allocated to a cache partition. In this embodiment, because the former method is to allocate a new cache to the target cache partition, based on a feature that the first cache benefit change is greater than the second cache benefit change, a target cache partition that has a larger positive benefit may be selected as an adjustment object to increase the cache size, so as to maximize a benefit. Because the latter method is to release a cache from the target cache partition to the idle shared cache, based on a feature that the third cache benefit change is less than the fourth cache benefit change, a target cache partition that has a smaller negative benefit may be selected as an adjustment object to decrease the cache size, so as to minimize a loss.

In an optional implementation, the cache benefit includes:

a benefit in quality of service, or a benefit by a service level agreement due to the benefit in quality of service,

It may be understood that the cache benefit is generated by adjusting the cache size of the cache partition, and many results may be obtained by adjusting the cache size of the cache partition. The foregoing two examples should not be construed as unique limitations to this embodiment of this application. The benefit in quality of service corresponds to a change in quality of service, such as an increase or a decrease of a cache hit ratio.

In an optional implementation, the benefit in quality of service includes a benefit by a cache hit ratio and/or a benefit by a cache read response time; and the benefit by the service level agreement due to the benefit in quality of service includes a benefit due to a penalty of the service level agreement due to a change in quality of service.

Examples of the benefit in quality of service and the benefit by the service level agreement due to the benefit in quality of service are described in this embodiment. As described above, the benefit in quality of service corresponds to the change in the quality of service. However, the change in the quality of service is not limited to the foregoing examples. The foregoing examples should not be construed as unique limitations to this embodiment of this application. In this embodiment, the benefit due to the penalty of the service level agreement may usually be a change of a penalty due to violation of the service level agreement, for example, an increase of the penalty and a change of an expense deduction coefficient.

In an optional implementation, before the obtaining a first cache size, the method further includes:

receiving a subscription request from the target tenant, recording subscription data of the target tenant, and creating the target cache partition for the target tenant, where the subscription data includes the service level agreement.

In this embodiment, the tenant may usually be corresponding to an enterprise. The enterprise serves as the tenant, and an employee of the enterprise serves as a user. The enterprise needs to register with, that is, subscribe to, a device that provides a service. During the subscription, the tenant usually reaches some agreements with a party that provides a service. The agreements herein may include a quantity of online users of the target tenant, and the quantity of online users herein is a maximum allowed quantity of online users. The agreements may further include a quality of service parameter, for example, a parameter that affects the quality of service, such as an average response time. The agreements may further include the service level agreement, that is, a penalty for violation of a quality of service requirement, and/or an incentive for providing quality of service better than quality of service originally specified.

In an optional implementation, this embodiment of this application further provides an implementation solution of analyzing the monitoring record, and the implementation solution is as follows. The analyzing the monitoring record includes:

analyzing the monitoring record based on a fitting function that includes an association among the adjustment size of the target cache partition, the cache size of the target cache partition, a usage amount of the target cache partition, a quantity of online users of the target tenant, and a cache hit ratio of the target cache partition.

In an optional implementation, this embodiment of this application further provides a more specific implementation solution of predicting and calculating the cache hit ratio based on the foregoing parameters and fitting function, and the implementation solution is as follows: The analyzing the monitoring record based on a fitting function that includes an association among the adjustment size of the target cache partition, the cache size of the target cache partition, a usage amount of the target cache partition, a quantity of online users of the target tenant, and a cache hit ratio of the target cache partition includes:

calculating the cache hit ratio based on the following formula:

$${Hiti}^{′} = Log \frac{Δ M * ( 1 / Ni ) * Pi * ( 1 / Ui )}{{hit}_{Lasti}} ,$$

where

the target tenant is an i^{th} tenant, Hiti′ represents a cache hit ratio of the i^{th} tenant, A Ni represents a quantity of online users defined in the service level agreement for the i^{th} tenant, hitₗₐₛₜᵢ represents a cache hit ratio after latest adjustment of a cache partition of the i^{th} tenant, Pi represents a cache size of the cache partition of the i^{th} tenant, Ui represents a cache size actually used in the cache partition of the i^{th} tenant, and ΔM represents an adjustment size of the cache partition of the i^{th} tenant.

In an optional implementation, because the difference between the second cache size and the first cache size is the adjustment size, this embodiment of this application further provides an adjustment size determining implementation solution, to determine a specific adjustment size to obtain a maximum benefit. The method further includes:

calculating the adjustment size of the target cache partition based on a fitting function that includes an association among a latest adjustment size of the target cache partition, a cache hit ratio after latest adjustment, a cache hit ratio before the latest adjustment, the quantity of online users of the target tenant, a cache utilization rate of the target cache partition, and a total cache size of all tenants.

In an optional implementation, to maximize the cache benefit, this embodiment of this application further provides a specific implementation solution of calculating the adjustment size based on the foregoing technical parameters, and the implementation solution is as follows. The calculating the adjustment size of the target cache partition based on a fitting function that includes an association among a latest adjustment size of the target cache partition, a cache hit ratio after latest adjustment, a cache hit ratio before the latest adjustment, the quantity of online users of the target tenant, a cache utilization rate of the target cache partition, and a total cache size of all tenants includes:

calculating the adjustment size of the target cache partition based on the following formula:

$$Δ M = {\vert Δ {M}_{lasti} \vert}^{*} {sin ( arch tan ( \frac{{hit}_{Lasti} - {hit}_{Lasti - 1}}{\vert Δ {M}_{lasti} \vert} ) )}^{*} {( 1 + Ui )}^{*} ( 1 + \frac{Ni}{{\sum }_{i = 0}^{tenantList . size} Ni} ) ,$$

where

ΔM represents the adjustment size of the cache partition of the i^{th} tenant, ΔMₗₐₛₜᵢ represents a cache size of the latest adjustment of the cache partition of the i^{th} tenant, hit_{Lasti} represents the cache hit ratio after the latest adjustment of the cache partition of the i^{th} tenant, hit_{Lasti-1} represents a cache hit ratio before the latest adjustment of the cache partition, Ni represents the quantity of online users defined in the service level agreement for the i^{th} tenant, Ui represents a cache utilization rate of the cache partition of the i^{th} tenant, archtan represents a tangent autoregressive conditional heteroscedasticity model, sin represents a sine function, and

$${\sum }_{i = 0}^{tenantList \cdot size} Ni$$

represents the total cache size of cache partitions of all the tenants.

In an optional implementation, due to relatively-heavy workload for calculating a cache adjustment size, this embodiment of this application further provides a pre-determining solution of quickly obtaining the adjustment size, and the solution is specifically as follows. Before the calculating the adjustment size of the target cache partition, the method further includes:

when determining that an average cache read response time of a user of the target tenant is less than or equal to a cache read response time specified in the service level agreement of the target tenant, and the quantity of online users of the target tenant is less than or equal to a quantity of online users specified in the service level agreement, determining that the adjustment size of the target cache partition is zero.

A calculation workload of this embodiment is extremely light, and a case in which the adjustment size is zero, in other words, a case in which the cache partition does not need to be adjusted can be quickly determined, so that unnecessary calculation is reduced.

According to a second aspect, an embodiment of this application provides a cache avocation apparatus, wherein the cache allocation apparatus is applied to software as a service SaaS that serves at least two tenants, the at least two tenants include a target tenant, a cache partition of the target tenant is a target cache partition, and the cache allocation apparatus includes:

a data obtaining unit, configured to obtain a first cache size and a monitoring record of the target tenant, where the monitoring record includes a correspondence between an adjustment size and a cache benefit change, and the first cache size is a current cache size of the target cache partition; and

a cache adjustment unit, configured to: analyze the monitoring record, and adjust the first cache size to a second cache size when determining that adjustment of the first cache size to the second cache size meets a cache benefit target,

In an optional implementation, the cache adjustment unit is configured to: allocate a cache of the adjustment size from an idle shared cache to the target cache partition when a first cache benefit change is greater than a second cache benefit change and a cache size of the idle shared cache is greater than the adjustment size, where the first cache benefit change corresponds to the target cache partition, and the second cache benefit change corresponds to a cache partition of all the other tenants in the at least two tenants; or

release a cache from the target cache partition when a third cache benefit change is less than a fourth cache benefit change and a cache size of the idle shared cache is less than the adjustment size, where the third cache benefit change corresponds to the target cache partition, and the fourth cache benefit change corresponds to a cache partition of all the other tenants in the at least two tenants.

In an optional implementation, the cache benefit includes:

a benefit in quality of service, or a benefit by a service level agreement due to the benefit in quality of service.

In an optional implementation, the benefit in quality of service includes a benefit by a cache hit ratio and/or a benefit by a cache read response time; and

the benefit by the service level agreement due to the benefit in quality of service includes a benefit due to a penalty of the service level agreement due to a change in quality of service.

In an optional implementation, the cache allocation apparatus further includes:

a request receiving unit, configured to receive a subscription request from the target tenant;

a data recording unit, configured to record subscription data of the target tenant; and

a partition creation unit, configured to create the target cache partition for the target tenant, where the subscription data includes the service level agreement.

In an optional implementation, the cache adjustment unit includes:

an analysis subunit, configured to analyze the monitoring record based on a fitting function that includes an association among the adjustment size of the target cache partition, the cache size of the target cache partition, a usage amount of the target cache partition, a quantity of online users of the target tenant, and a cache hit ratio of the target cache partition.

In an optional implementation, the analysis subunit is configured to calculate the cache hit ratio based on the following formula:

$${Hiti}^{′} = Log \frac{Δ M * ( 1 / Ni ) * Pi * ( 1 / Ui )}{{hit}_{Lasti}} ,$$

where the target tenant is an i^{th} tenant, represents a cache hit ratio of the i^{th} tenant, represents a quantity of online users defined in the service level agreement for the i^{th} tenant, hit_{Lasti} represents a cache hit ratio after latest adjustment of a cache partition of the i^{th} tenant, Pi represents a cache size of the cache partition of the i^{th} tenant, Ui represents a cache size actually used in the cache partition of the i^{th} tenant, and ΔM represents an adjustment size of the cache partition of the i^{th} tenant.

In an optional implementation, the cache adjustment unit includes:

a calculation subunit, configured to calculate the adjustment size of the target cache partition based on a fitting function that includes an association among a latest adjustment size of the target cache partition, a cache hit ratio after latest adjustment, a cache hit ratio before the latest adjustment, the quantity of online users of the target tenant, a cache utilization rate of the target cache partition, and a total cache size of all tenants.

In an optional implementation, the calculation subunit is configured to calculate the adjustment size of the target cache partition based on the following formula:

$$Δ M = \vert Δ {M}_{lasti} \vert * sin ( arch tan ( \frac{{hit}_{Lasti} - {hit}_{Lasti - 1}}{\vert Δ {M}_{lasti} \vert} ) ) * ( 1 + Ui ) * ( 1 + \frac{Ni}{{\sum }_{i = 0}^{tenantList \cdot size} Ni} ) ,$$

where

ΔM represents the adjustment size of the cache partition of the i^{th} tenant, ΔM_{Lasti} represents a cache size of the latest adjustment of the cache partition of the i^{th} tenant, hit_{Lasti} represents the cache hit ratio after the latest adjustment of the cache partition of the i^{th} tenant, hit_{Lasti-1} represents a cache hit ratio before the latest adjustment of the cache partition, Ni represents the quantity of online users defined in the service level agreement for the i^{th} tenant, Ui represents a cache utilization rate of the cache partition of the i^{th} tenant, archtan represents a tangent autoregressive conditional heteroscedasticity model, sin represents a sine function, and

$${\sum }_{i = 0}^{tenantList \cdot size} Ni$$

represents the total cache size of cache partitions of all the tenants.

In an optional implementation, the cache adjustment unit is further configured to: when determining that an average cache read response time of a user of the target tenant is less than or equal to a cache read response time specified in the service level agreement of the target tenant, and the quantity of online users of the target tenant is less than or equal to a quantity of online users specified in the service level agreement, determine that the adjustment size of the target cache partition is zero.

According to a third aspect, an embodiment of this application provides another cache allocation apparatus, including a cache, a processor, and an input/output device. The cache includes a cache partition of a tenant, and the processor has a function of executing executable code or implementing, by using hardware, the method in one of the foregoing first aspects.

In the embodiments of this application, because the monitoring record includes the correspondence between an adjustment size and a cache benefit change, a cache benefit obtained by adjusting a cache size of a cache partition may be predicted based on the monitoring record of the tenant. In this case, a to-be-adjusted cache partition, and whether to increase or decrease a cache size of the cache partition may be determined based on the cache benefit target, so that a higher cache benefit is obtained and a cache sharing utilization rate is correspondingly increased.

### BRIEF DESCRIPTION OF DRAWINGS

The following describes the accompanying drawings used for describing the embodiments of this application;

FIG. 1 is a schematic structural diagram of a system according to an embodiment of this application;

FIG. 2 is a schematic flowchart of a method according to an embodiment of this application;

FIG. 3 is a schematic diagram of an association between a tenant cache partition size and a tenant cache partition hit ratio according to an embodiment of this application;

FIG. 4 is a schematic structural diagram of an apparatus according to an embodiment of this application;

FIG. 5 is a schematic structural diagram of an apparatus according to an embodiment of this application; and

FIG. 6 is a schematic structural diagram of a server according to an embodiment of this application.

### DESCRIPTION OF EMBODIMENTS

The following describes the embodiments of this application with reference to the accompanying drawings in the embodiments of this application.

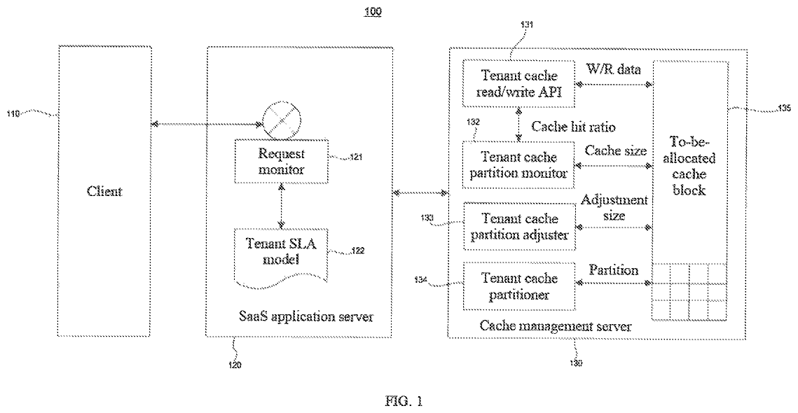

FIG. 1 is a structural diagram of a system 100 according to an embodiment of this application, and the system 100 includes the following three parts: a client 110, an SaaS application server 120, and a cache management server 130.

The client 110 is configured to: display an SaaS application operation interface, and generate data based on a user operation and send the data to the SaaS application server 120. A function of the client 110 is to communicate with a user.

The SaaS application server 120 is configured to process a data write/read (Write/Read, W/R) request initiated by a tenant, where the data read request relates to a data query, and the write request relates to a data update. The SaaS application server 120 provides services such as data query, update, and transaction management for the tenant.

The cache management server 130 is configured to: provide a cache service for the SaaS application server 120, and provide a dynamic cache service based on a cache partition for the tenant.

Components included in the SaaS application server 120, and components included in the cache management server 130 and functions of the components are separately described in the following embodiments.

The SaaS application server 120 includes the following units: a request monitor 121 and a tenant SLA model 122.

The request monitor 121 monitors response duration of service requests initiated by users of all tenants (for example, a time difference between a time at which a user initiates a request for an ordering service and a time at which the ordering service is completed), collects statistics about a quantity of all online users of a current tenant based on the service requests initiated by users, and records monitoring records. The following shows an example:

```
        [
        {
        “tenant”:“huawei”,//a tenant identifier
        “Nuser”:50,//a current quantity of online users of the tenant
        “rejectNuser”:0,//a quantity of users that are rejected after a
maximum quantity of users is exceeded
        “requestList”://a set of user request records of the tenant Huawei
        [
        request://a record of one service request of the tenant Huawei
        {
        recieveTime:2016-10-22 20:10:66.2222,//service request
        receiving time
        responseTime:200ms//service request response duration
        }
        ]
        ].
```

When a tenant performs registration, the tenant SLA model 122 generates SLA data based on registration information of the tenant. The SLA data includes, for example, a quantity of online users of the target tenant, a service response time, and a penalty item (for example, when an SLA violation rate is 0<&<5%, charging 95% of a fee or directly setting a penalty amount such as $100) for a SeaS application provider when the SaaS application provider violates an SLA. For example, an SLA model for the tenant Huawei is as follows:

{
“tenant”:“huawei”,//a tenant identifier
SLA://an SLA for the tenant Huawei
{
nuser:100,//a quantity of online users
responseTime:200ms,//service request response duration
penalty:$800//a penalty value for violation of the SLA
}
}.

The cache management server 130 includes the following units: a multi-tenant shared cache, a tenant cache partitioner 134, a tenant cache partition monitor 132, and a tenant cache partition adjuster 133.

The multi-tenant shared cache is shown in FIG. 1, and the multi-tenant shared cache includes two parts: a to-be-allocated cache block 135 and a cache partition of a tenant. The multi-tenant shared cache is a data cache, and is partitioned based on tenants because a plurality of tenants share a same cache resource. Each cache partition is used to cache data of a corresponding tenant. The multi-tenant shared cache may be a memory or a storage register. The cache partition is shown in a square area of FIG. 1. During subscription, the cache partition may have a fixed cache size, and the cache size of the cache partition is dynamically adjusted during subsequent use of the tenant.

The tenant cache partitioner 134 creates a cache partition in the storage register/memory when the tenant performs subscription, and records a mapping relationship between a tenant and a partition. The following shows an example:

A cache partition with a cache size of 1 M and an identifier of p0 is created for the tenant Huawei, and a data record of the cache partition is as follows:

```
        [
        {
        “tenant”:“huawei”,//a tenant identifier
        “partition”:“phuawei”,//an identifier of the cache partition
created for the tenant Huawei
        “size”:“1m”//storage space in which a cache size of the
cache partition of the tenant Huawei is 1 M
        “time”:2016-10-22 12:30:11.210//a cache partition creating time
        }
        ].
```

The tenant cache partition monitor 132 is configured to: monitor a cache size of a tenant cache partition, an actually used cache size, and a hit result of tenant cache read; and record the hit result as a monitoring record. The following shows an example:

```
        {
        “tenant”:“huawei”,//a tenant identifier
        “totalSize”:“12m”,//a cache size of a cache partition of the
        tenant Huawei
        “usedSize”:“11m”,//a cache size used in the cache partition
        of the tenant Huawei
        hitRecords://a data record about whether a user of the
tenant Huawei hits a cache partition each time the user accesses the
cache partition
        [
        {//this segment is a cache partition access record, and it is
assumed that cache access hits
        “time”:“2016-10-25 13:56:30.0200”,//a time at which the
cache partition is accessed
        “key”:“test1”,//an identifier value of an accessed cache entry
        “hit”:“yes”//hit or not, yes means hit, and no means miss
        }, and
        {//this segment is another record of accessing a cache partition,
and it is assumed that cache access misses. For a related description, refer
to the description of the previous record.
        “time”:“2016-10-25 13:56:30.0100”,
        “key”:“test2”,
        “hit”:“no”
        },
        ]
        }.
```

The tenant cache partition adjuster 133 is configured to: analyze a monitoring record of the tenant cache partition, generate a usage characteristic of the cache partition, and dynamically adjust a cache size of a cache partition for each tenant based on the usage characteristic, so as to continuously increase a cache hit ratio of the cache partition and maximize an overall cache hit ratio. The tenant cache partition adjuster 133 may preferably adjust a cache partition corresponding to a tenant that has a relatively high cache benefit ratio or a large SLA penalty factor, so as to maximize a cache utilization rate and a cache benefit; and when there is no idle cache resource that can be allocated to a cache partition of a tenant in an overall cache, recycle a cache in a cache partition of a tenant with a low cache benefit ratio and allocate the recycled cache to a cache partition of a tenant with a high cache benefit. The cache benefit ratio is a ratio of an increased cache hit ratio to a cache adjustment size. For example, if the hit ratio is increased by 20% and the cache adjustment size is 20 M, the cache benefit ratio is 20%/20=1%. The low cache benefit refers to a low cache benefit ratio or a small SLA penalty factor, and the high cache benefit refers to a high cache benefit ratio or a large SLA penalty factor. Adjustment data is recorded each time a cache size of the cache partition of the tenant is adjusted. The following shows an example:

```
        {
        “tenant”:“huawei”,//a tenant identifier
        “adjustedSize”:“3m”,//an adjustment size of a current
cache partition for the tenant Huawei
        “operateType”:“increase”,//an adjustment type of the cache
partition for the tenant Huawei, where if a value of an operateType is
“increase”, such operateType indicates increasing in a cache size of the
cache partition, or if a value of an operateType is “decrease”, such
operateType indicates decreasing in a cache size of the cache partition
        “time”2016-10-25 10:36:20.200://a time at which a cache size
of the cache partition of the tenant Huawei is adjusted
        }.
```

Tenant cache read/write application programming interface (Application Programming Interface, API) 131: The SaaS application server 120 sends a cache request to a cache management server 130, so that data in the tenant cache partition is read and written through the API when cached data is to be read and written. The following shows an example:

```
        {
        writeCacheData(“huawei”,“{loginedUser:{name:test,
mobile:1803545451}}”)//write cached data
        readCacheData (“huawei”,“loginedUser”)//read cached data
whose key is user from the cache partition of the tenant Huawei
        return “{user:{name:test,age:22}}”//return the cached data
        }.
```

A command from the tenant cache partition adjuster 133 is received to release cache space of the tenant cache partition. For example, the tenant cache partition adjuster 133 invokes a freeSize interface:

freeSize(huawei,1 m)//1-M cache space is released from the cache partition of the tenant Huawei.

Content that may be defined in the freeSize interface includes:

locating the cache partition of the tenant Huawei, determining a location of the cache partition of the tenant Huawei, and releasing a cache occupied by a cache entry which is less frequently used. Specifically, the content may be: obtaining times of reading various cache entries in the cache partition of the tenant Huawei, sequentially accumulating cache sizes occupied by the cache entries in ascending order of the times of reading the various cache entries; and when a calculated accumulation value of cache sizes is greater than or equal to 1 M, stopping collecting statistics and deleting caches occupied by cache entries involved in the statistics.

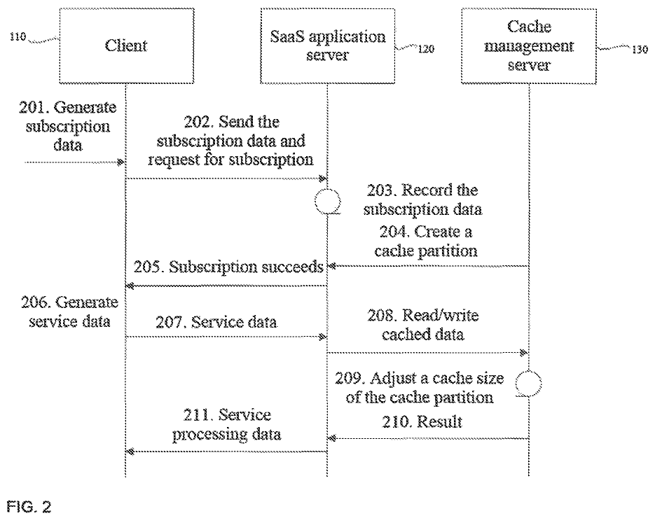

Based on the foregoing descriptions of the system architecture and each component, an embodiment of this application provides the following cache allocation solution. This embodiment is described by using an example in which a tenant performs subscription, a cache partition is created for the tenant, and then a cache size of the cache partition is adjusted. A specific processing process is shown in FIG. 2.

201. A client 110 generates subscription data.

Specifically, for example, a tenant Huawei fills in the subscription data by using the client 110 and submits an application to request a system to perform subscription. For example, a tenant name in subscription information is Huawei, and an SLA may include the following information: a maximum allowed quantity of online users, service request response duration, and SLA violation penalty information.

202. The client 110 sends the subscription data of a tenant in step 201 to an SaaS application server 120 to request to subscribe for the tenant Huawei.

203. The SaaS application server 120 records the subscription data of the tenant Huawei after receiving a subscription request from the tenant Huawei.

The subscription information of the tenant Huawei is specifically recorded as follows:

{
“tenant”:“huawei”,//a tenant identifier
SLA://an SLA for the tenant Huawei
{
nuser:100,//a maximum allowed quantity of online users
responseTime:200ms,//service request response duration
penalty:$800//a penalty value for violation of the SLA
}
}.

204. The SaaS application server 120 creates a cache partition for the tenant Huawei.

The cache partition is created by a tenant cache partitioner 134 in a cache management server 130. For details, refer to the system 100 description shown in FIG. 1.

That the SaaS application server 120 creates the cache partition for the tenant Huawei is specifically as follows:

(1). The SaaS application server 120 creates the cache partition for the tenant Huawei in a multi-tenant shared cache, where a cache size of the cache partition may be initialized to a preset value, such as 1 M, and an identifier of the cache partition is phuawei. A manner of creating a cache partition storage block is as follows: char×phuawei=new char [1024×1024].

(2). To create the cache partition for the tenant Huawei, the SaaS application server 120 further may record a data model for a mapping relationship between the tenant Huawei and the cache partition. Details are as follows:

```
{
“tenant”:“huawei”,//a tenant identifier
“partition”:“phuawei”,//an identifier of the cache partition created for the
tenant Huawei
        “size”:“1m”//storage space in which storage size of the
cache partition of the tenant Huawei is 1 M
        “time”:2016-10-22 12:30:11.210
        }.
```

205. A cache management server 130 may send, to the SaaS application server 120, information indicating that the cache partition is successfully created for the tenant Huawei, and the SaaS application server 120 returns a message of successful subscription of the tenant Huawei to the client 110.

206: Tenant performs operation on a client side, and the operation may result in generating service data.

207. The client 110 records the tenant operation, generates the corresponding service data, and sends the service data to the SaaS application server 120.

208. The SaaS application server 120 requests the cache management server 130 to query for cached data.

Referring to the system 100 shown in FIG. 1, a specific process of querying for the cached data is as follows:

(1). The SaaS application server 120 sends a query request to a tenant cache read/write API 131 to query for the cached data. For example, when a user places an order, an order number sent based on a mobile phone number needs to be queried for in a cached data entry of a current login user, and an identifier that is of the cached data entry and that is stored in a tenant cache partition is “loginedUser”.

(2). The tenant cache read/write API 131 requests, based on a service request that carries a tenant identifier Huawei, to query for cached data whose identifier is “loginedUser, where query request information is, for example, {“tenant”:“huawei”,“cacheKey”:“IoginedUser”}.

(3). The tenant cache read/write API 131 sends the tenant identifier Huawei to request a tenant cache partitioner 134 to query from a partition allocated to the Huawei. For example, a cache partition whose identifier is phuawei is found.

(4). The tenant cache read/write API 131 sends the tenant identifier to query for an identifier of the cached data, and queries from the cache partition for the cached data. For example, the found cached data is as follows:

{“name:test, mobile:1803545451}}”

2085. The tenant cache read write API 131 returns a query result of the cached data.

2086. The tenant cache read/write API 131 notifies a tenant cache partition monitor 132 of a cache hit result.

The cache hit result is determined depending on a cache query result. If the cache query result is empty, a cache miss occurs, or if the cache query result is not empty, a cache hit occurs.

2087. The tenant cache partition monitor 132 records the cache query hit result of the tenant cache partition. The following shows an example:

```
        {
        “tenant”:“huawei”,//a tenant identifier
        “totalSize”:“12 m”,//a cache size of a cache partition of the
        tenant Huawei
        “usedSize”:“11m”,//a cache size used in the cache partition
        of the tenant Huawei
        hitRecords://a data record about whether a user of the tenant
Huawei hits a cache partition each time the user accesses the
cache partition
        [
        ...//the following is an example of a historical record
        {
        “time”:“2016-10-25 13:56:30.0200”,//an access time
        “key”:“loginedUser”,//an identifier of an accessed cache entry
        “hit”:“yes”//hit or not, yes means hit, and no means miss
        }
        ]
        }.
```

209. The tenant cache partition monitor 132 instructs a tenant cache partition adjuster 133 to adjust, online in real time, a cache size of the tenant cache partition based on a tenant cache partition query hit ratio and a tenant cache partition benefit.

The tenant cache partition adjuster 133 records an adjustment type, an adjustment size, and an adjustment time of the tenant cache partition.

The adjustment type herein includes increasing the cache size or decreasing the cache size.

The tenant cache partition adjuster 133 updates, to an adjusted value, a cache size that is of a tenant cache partition and that is recorded by the tenant cache partitioner 134. For example, a cache size of a cache partition in a record model of the tenant Huawei is shown in Table 1 below.

TABLE 1

| Tenant identifier T | Cache partition identifier | Cache partition size |
|---|---|---|
| Huawei | P 1 | 1.5 M |

210. Return the found cached data.

211. Return a service processing result.

Step 209 in the foregoing implementation is described in the following embodiment. In this step, three problems need to be resolved: 1. how to predict a cache benefit change after the cache size of the cache partition is adjusted; 2. how to determine the adjustment size; and 3. how to perform specific adjustment after the adjustment size and the change are determined. Based on the three problems, this embodiment is described as follows:

1. After the cache size of the cache partition is adjusted, the cache benefit change is specifically predicted as follows:

Step A: The tenant cache partition adjuster 133 queries for requests recorded from all monitoring records.

The following shows an example of the requests recorded in the monitoring records:

```
        [
        {
        “tenant”:“huawei”,//a tenant identifier
        “Nuser”:50,//a current quantity of online users of the tenant
        “rejectNuser”:0,//a quantity of users that are rejected after a
maximum quantity of users specified in an SLA is exceeded
        “requestList”://a service request record of a user of the
        tenant Huawei
        [
        ...
        request://a record of one service request of the user of the
        tenant Huawei
        {
        recieveTime:2016-10-22 20:10:66.2222,//service request
        receiving time
        responseTime:200ms//service request response duration
        }
        ]
        },
        {
        “tenant”:“test2”,//a tenant identifier
        “Nuser”:10,//a current quantity of online users of the tenant
        “requestList”://a set of service request records of a user of the
        tenant Huawei
        [
        ...
        request://a record of one service request of the tenant Huawei
        {
        recieveTime: 2016-10-22 20:15:66.2222,//a request
        receiving time
        responseTime:100ms//request response duration
        }
        ]
        }
        ].
```

The following shows an example of data recorded in a monitoring records of a tenant cache partition:

```
        {
        “tenant”:“huawei”,//a tenant identifier
        “totalSize”:“12m”,//a cache size of a cache partition of the
tenant Huawei, namely, a total size of a cache occupied
by the cache partition
        “usedSize”:“11m”,//a cache size used in the cache partition
        of the tenant Huawei
        hitRecords://a data record about whether a user of the tenant
Huawei hits a cache partition each time the user accesses the cache
partition
        [
        {//this segment is a cache partition access record, and it is
assumed that cache access hits
        “time”:“2016-10-25 13:56:30.0200”,//an access time
        “key”: “test1”,//an identifier value of an accessed cache entry
        “hit”:“yes”//hit or not, yes means hit, and no means miss
        },
        {//this segment is another record of accessing a cache partition,
and it is assumed that cache access misses. For a related description, refer
to the description of the previous record.
        “time”:“2016-10-25 13:56:30.0100”,
        “key”:“test2”,
        “hit”:“no”
        },
        ...
        ]
        }
```

Step B: The tenant cache partition adjuster 133 reads all tenant SLA models. The following shows an example:

[{
“tenant”:“huawei”,//a tenant identifier
SLA://an SLA for the tenant Huawei
{
nuser:100,//a maximum allowed quantity of online users
responseTime:200ms,//service request response duration
penalty:$800//a penalty value for violation of the SLA
}
},
{
“tenant”:“test”,//a tenant identifier
SLA://an SLA for the tenant test
{
nuser:60,//a maximum allowed quantity of online users
responseTime:300ms,//service request response duration
penalty:$500//a penalty value for violation of the SLA
}
}
]

Step C: The tenant cache partition adjuster 133 analyzes the requests recorded in the monitoring records and data recorded in the monitoring records, and establishes, with reference to the tenant SLA model 122, a fitting function that includes an association among an adjustment size of a cache partition, a size of the cache partition, a usage size of the cache partition, a user quantity, and a hit ratio of the cache partition. The adjustment size of the cache partition is simply referred to as an adjustment size, the size of the cache partition is a cache size of the cache partition, the usage size of the cache partition is a usage of the cache partition, and the user quantity is a quantity of online users of the target tenant. A maximum quantity of online users is specified in the SLA, and the hit ratio of the cache partition is a cache hit ratio of the cache partition. The fitting function is used to predict a cache hit ratio that is obtained after the tenant cache partition is adjusted based on an adjustment size. For example, a function expression for predicting the cache hit ratio of the tenant cache partition provided in this embodiment is as follows:

$${Hiti}^{′} = Log \frac{Δ M * ( 1 / Ni ) * Pi * ( 1 / Ui )}{{hit}_{Lasti}} \qquad ( f1 )$$

Hiti′ is a cache hit ratio predicted after a cache size of a cache partition of an i^{th} tenant is adjusted.

Ni is a quantity of online users (namely, a maximum quantity of online users) that is defined in the SLA for the i^{th} tenant, and a quantity of online users “nuser” of each tenant is obtained through reading a tenant SLA. For example, the quantity of online users of the tenant Huawei is N=100.

hit_{Lasti} is a hit ratio that is obtained after the latest adjusted cache size of the cache partition of the i^{th} tenant. This value can be obtained specifically in the following manner: analyzing a monitoring record of the tenant cache partition and collecting statistics about cache hit ratios of the cache partition within a time interval of latest adjustment of the tenant cache partition. For example, in a statistics interval of the tenant Huawei, a start time of the latest adjustment of the cache partition is R(last).time=2016-10-22 10:21:34.321, and an end time is a current system time System.currentTime. In this case, the time interval of the latest adjustment of the tenant cache partition is a time period from R (last).time to System.currentTime. The cache hit ratio may be calculated by dividing a quantity of records of hit:“Yes” in the monitoring record of the cache partition by a total quantity of records. For example, a calculated result is: hitLast=90%.

Pi is a cache size of the cache partition of the i^{th} tenant. totalSize in the monitoring record of the tenant cache partition is read. For example, totalSize of the tenant Huawei is 12 M.

Ui is a cache size actually used in the cache partition of the i^{th} tenant.

usedSize in a set of historical monitoring records of the tenant cache partition is read. For example, usedSize of the tenant Huawei is 11 M.

ΔM is the adjustment size of the cache partition, and it is assumed that a preset adjustment size is 0.5 M. Adjusting the cache size of the cache partition causes an increase or a decrease in the cache hit ratio of the tenant cache partition. A cache hit ratio of each tenant cache partition is continuously increased by dynamically and continuously adjusting the cache size of the tenant cache partition, so as to increase an overall cache hit ratio and maximize a cache benefit.

In addition, there is an association between a tenant cache partition size and a tenant cache partition hit ratio, that is, between the cache size and the cache hit ratio, as shown in FIG. 3.

For different tenants and different cache partition sizes, adjusting cache partitions by a same cache size results in a big difference in changes of hit ratios of the cache partitions. For example, a site A and a site A′ of the tenant huawei are compared. A cache benefit ratio at the site A is higher, and therefore, a cache partition size should be adjusted by a larger adjustment value at the site A. A cache benefit ratio at the site A′ is lower, and therefore, a cache partition size should be adjusted by a smaller adjustment value for a plurality of times at the site A′, so that more cache resources are scheduled and allocated to an adjustment site that has a larger benefit ratio and a cache benefit is increased. Compared with the site A of the tenant Huawei A, a site 8 of a tenant tenant1 has a lower cache benefit ratio. Likewise, when a cache partition of the tenant tenant1 is adjusted, the cache partition of the tenant tenant1 should be adjusted by a smaller adjustment value than the adjustment value used to adjust the cache partition of the tenant Huawei, and more cache resources are scheduled and allocated to the tenant Huawei that has a higher cache benefit ratio. Multi-tenant, multi-stage, and refined scheduling and allocation of cache resources are implemented with reference to a usage characteristic of the cache partition of each tenant, so as to further increase an overall utilization rate and an overall cache hit ratio of the cache resources and maximize a cache benefit.

2. This embodiment further provides a specific implementation solution of determining the adjustment size:

A key to adjust a cache partition size in a refined manner is to evaluate and calculate each adjustment size.

This embodiment further includes dynamically calculating an adjustment size (that is, optimized ΔM′) of a tenant-oriented cache partition based on a historical adjustment record of a cache size of a cache partition, monitoring data in a monitoring record of the cache partition, a historical request monitoring record, and a tenant SLA model 122. The adjustment size corresponds to an adjustment size in the system 100 shown in FIG. 1. Before the tenant cache partition adjuster 133 adjusts the cache size of the cache partition, the following method is performed to further calculate an optimized adjustment size and the following steps are included.

Step A: Read a historical cache adjustment record, data in the monitoring record of the cache partition, a monitoring record of a tenant service request, and the tenant SLA model 122.

The following shows an example of the historical cache adjustment record.

```
        [{
        tenant:“huawei”//a tenant to which a cache partition belongs
        adjustRecords://an adjustment record of the cache partition
        [
        {time:2016-10-22 10:21:34.321,value:4m},//an adjustment
time is 2016-10-22 10:21:34, and an adjustment size is 4 M. Another
record is not described.
        {time:2016-10-22 10:18:33.321,value:2.5m},
        {time: 2016-10-22 10:18:32.321,value:1.5m},
        {time: 2016-10-22 10:18:31.321,value:1.0m},
        {time:2016-10-22 10:18:30.321,value:0.5m}
        ]
        }].
```

Step B: Calculate an optimized value ΔM′: calculating a monitoring record of a tenant service request received after a start time, which is a most recent time on which a tenant adjusted the cache partition, that is, a monitoring record of a service request whose receiving time is later than the start time; collecting statistics about average response duration of each service request (a sum of response duration of all service requests divided by a quantity of service requests); and reading, from the monitoring record of the service request, a quantity of online users of the tenant.

Step B1: When the average tenant service request response duration is less than or equal to request response duration defined in the tenant SLA model 122, and a recorded quantity of rejected users is zero, the tenant SLA is satisfied. In this case, ΔM′=0 may be determined.

Step B2: When the average tenant service request response duration is greater than request response duration defined in the tenant SLA model 122, the tenant SLA is not satisfied, and a method for calculating the optimized value includes the following steps.

Step B3: Read latest two adjustment records {R(last), R(last-1)) of the cache partition of the tenant from the monitoring record. For example, latest two adjustment records of a cache partition corresponding to the tenant Huawei are as follows:

{{time: 2016-10-22 10:21:34.321,value:4 m},{time:2016-10-22 10:18: 33.321, value:2.5}}.

An adjustment size ΔMlast of the latest adjustment of the tenant cache partition is calculated. For example, a latest adjustment value of the tenant Huawei is 4 M.

Step B4: Calculate cache hit ratios within a time interval of latest two times of cache size adjustment of the cache partition.

The monitoring record of the tenant cache partition is analyzed, and a cache hit ratio of the cache partition within a time interval of the latest adjustment of the cache size of the tenant cache partition is calculated. For example, in the foregoing historical cache adjustment record, a first entry, that is, a record of the latest adjustment of the cache partition is {time:2016-10-22 10:21:34.321,value:4m}, which indicates that in a statistical interval of the tenant Huawei, a start time of the latest adjustment of the cache partition is R(last).time =2016-10-22 10:21:34.321, and an end time is a current system time System.currentTime. In the foregoing historical cache adjustment record, a second entry, that is, a record of adjustment prior to the latest adjustment of the cache partition is {time:2016-10-22 10:18:33.321,value:2.5m}, which indicates that in a statistical interval of the tenant Huawei, a start time of the adjustment prior to the latest adjustment of the cache partition is (R(last-1).time=2016-10-22 10:18:33.321, and an end time is R(last).time 2016-10-22 10:21:34.321. For example, cache hit ratios are respectively: hitLast=90%, and hitlast-1 =75%.

Step B5: Calculate a cache utilization rate of each tenant cache partition.

A cache size and a used cache size of each tenant cache partition are read, and the cache utilization rate U of each tenant cache partition is calculated. The cache utilization rate U is calculated as follows: (the used cache size divided by the cache size of the cache partition)×100%. For example, in the foregoing example, the cache size of the cache partition recorded in the record of the tenant Huawei is “totalSize”:“12 m”, the used cache size is “usedSize”:“11 m”. In this case, the cache utilization rate U is (11/12)×100%=91.7%.

Step B6: Read the tenant SLA to obtain a quantity of online users of each tenant.

In the foregoing example, the quantity of online users is a value N of nuser. For example, the quantity of online users of the tenant Huawei is N=100.

Step B7: Calculate the optimized adjustment size ΔM′ based on the foregoing data. For example, a calculation expression is as follows:

$$Δ M = \vert Δ {M}_{lasti} \vert * sin ( arch tan ( \frac{{hit}_{Lasti} - {hit}_{Lasti - 1}}{\vert Δ {M}_{lasti} \vert} ) ) * ( 1 + Ui ) * ( 1 + \frac{Ni}{{\sum }_{i = 0}^{tenantList \cdot size} Ni} ) \qquad ( f2 )$$

M′ is an optimized adjustment size of a cache partition of a tenant i. When hit _{Lasti}−hit_{Lasti-1}>0, a tenant cache partition size is increased, and more cache resources are allocated. When hit_{Lasti}−hit_{Last-1}<0, a tenant cache partition size is decreased, and a cache resource is released.

ΔM_{Lasti} is a cache size of the latest adjustment of the cache partition of the tenant i. For example, a cache size of latest adjustment of the cache partition of the tenant Huawei is 4 M. When a cache size of the latest adjustment of the cache partition of the tenant is 0, that is, ΔM_{Lasti}=0, a set of partition adjustment records of the tenant is traversed in descending order of time until a recorded adjustment value ΔM is not equal to 0, and ΔM _{Lasti}ΔM is set.

hit_{Lasti} is a cache hit ratio after the latest adjustment of the cache partition of the tenant i, For example, a cache hit ratio after the latest adjustment of the cache partition of the tenant Huawei in the foregoing example is 90%.

hit^{Lasti-1} is a cache hit ratio before the latest adjustment of the cache partition of the tenant i. For example, a cache hit ratio of adjustment previous to the latest adjustment of the cache partition of the tenant Huawei in the foregoing example is 75%.

Ni is a quantity of online users that is defined in the SLA for the tenant i, namely, a maximum quantity of online users allowed for the tenant. For example, a maximum quantity of online users allowed for the tenant Huawei is 100.

Ui is a cache utilization rate of the cache partition of the tenant i. For example, a value a current cache utilization rate of the cache partition of the tenant Huawei is 91.7%.

For example, an optimized cache adjustment size calculated for the tenant Huawei based on the foregoing formula (f2) may be 7 M.

Step C: When the cache partition adjuster is triggered again to adjust the tenant cache partition, the cache partition adjuster predicts cache hit ratios after adjustment of all tenants based on the foregoing formula (f1) for predicting the tenant cache hit ratio, and calculate a benefit ratio |Δhit/ΔM| of a change Δhit of the hit ratio of the cache partition to the adjustment size ΔM of the cache partition, as shown in Table 2 below.

TABLE 2
Benefit ratio queue of cache adjustment size

| | Current | | Predicted cache | Incremental |
|---|---|---|---|---|
| Tenant | cache hit | Adjustment | hit ratio after | cache |
| identifier | ratio % | size M | adjustment % | benefit ratio |
| Huawei | 90 | 7 | 98 | (98%-90%)/7 = |
| | | | | 1.1% |
| Tenant1 | 30 | 3 | 32 | (32%-30%)/3 = |
| | | | | 0.6% |

3. Select a cache partition that needs to be adjusted, and determine how to perform specific adjustment. In this embodiment, adjustment may be performed after the parameters in the foregoing two aspects are prepared, that is, performed after the adjustment size and the benefit change are determined.

With reference to the system 100 shown in FIG. 1, the tenant cache partition adjuster 133 adjusts the tenant cache partition based on the benefit ratio, the SLA model, and monitoring information, to maximize a benefit by the SaaS service provider. A specific process is as follows:

Step A: Identify a tenant that meets the SLA as a queue S1, and identify a tenant whose response time and quantity of online users do not meet the SLA as a queue S2.

Step B: It is assumed that an adjustment size is greater than zero.

Step B1: If an idle resource of a multi-tenant shared cache is greater than or equal to the adjustment size, the following cases may occur:

If the queue S2 is empty, cache space of the adjustment size may be allocated to a tenant that has a maximum benefit ratio, so as to maximize an overall cache hit ratio. It is assumed that the tenant that has a maximum benefit ratio is Huawei, a cache is allocated from an idle shared cache to a cache partition of the tenant Huawei.

If the queue S2 is not empty, a cache may be allocated to a tenant that has a large penalty factor and that can achieve a maximum to-be-increased hit ratio, so as to minimize a loss of the service provider.

Step B2: If an idle resource of a multi-tenant shared cache is less than the adjustment size, the following case may occur:

In this case, a part of the cache that has been allocated to a cache partition needs to be released and is used as an idle resource. Specifically, the process may be: calculating a cache utilization rate of each tenant based on a monitoring record of the cache partition, identifying a tenant that has a low cache utilization rate, a low cache hit ratio benefit, and a small penalty factor, releasing the cache of the identified tenant, and then allocating the released cache to a cache partition of a tenant that has a maximum cache benefit ratio and a maximum penalty factor.

Step C: It is assumed that the adjustment size is less than zero, the cache partition read/write API may be requested to release the cache space, and the cache space is used as idle space and allocated to a cache partition of all the other tenants.

The foregoing describes the method in the embodiments of this application in detail, and the following provides an apparatus in the embodiments of this application.

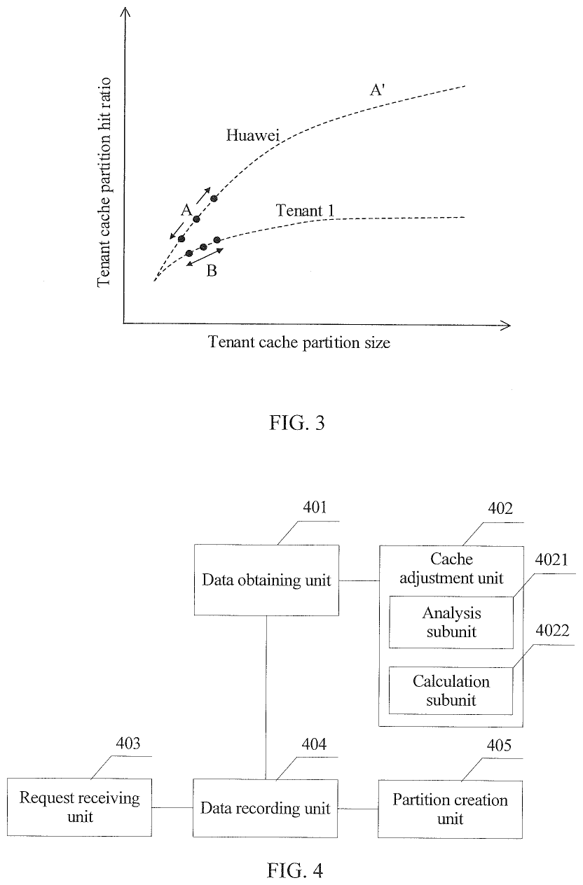

FIG. 4 is a schematic structural diagram of a cache allocation apparatus according to an embodiment of this application. The cache allocation apparatus is applied to software as a service SaaS that serves at least two tenants. The at least two tenants include a target tenant, a cache partition of the target tenant is a target cache partition. The cache allocation apparatus may include a data obtaining unit 401 and a cache adjustment unit 402, and a detailed description of each unit is as follows:

The data obtaining unit 401 is configured to obtain a first cache size and a monitoring record of the target tenant, wherein the monitoring record includes a correspondence between an adjustment size and a cache benefit change, and the first cache size is a current cache size of the target cache partition.

The cache adjustment unit 402 is configured to: analyze the monitoring record, and adjust the first cache size to a second cache size when determining that adjustment of the first cache size to the second cache size meets a cache benefit target.

For this embodiment, refer to the foregoing method embodiments and the description of the method embodiments in this specification. Details are not described herein again. In apparatus embodiments following this embodiment, refer to the content of the method embodiments. In this embodiment, the data obtaining unit 401 may be corresponding to the request monitor 121 and the tenant cache partition monitor 132 in the system structure in FIG. 1. The cache adjustment unit 402 may be corresponding to the tenant cache partition adjuster 133 in the system 100 in FIG. 1.

In this embodiment of this application, because the monitoring record includes the correspondence between an adjustment size and a cache benefit change, a cache benefit obtained by adjusting a cache size of a cache partition may be predicted based on the monitoring record of the tenant. In this case, a to-be-adjusted cache partition, and whether to increase or decrease a cache size of the cache partition may be determined based on the cache benefit target, so that a higher cache benefit is obtained and a cache sharing utilization rate is correspondingly increased.

In an optional implementation, this embodiment of this application further provides a specific implementation solution of allocating a new cache to the target cache partition and releasing a cache from the target cache partition, and the implementation solution is as follows:

The cache adjustment unit 402 is configured to: allocate a cache of the adjustment size from an idle shared cache to the target cache partition when a first cache benefit change is greater than a second cache benefit change and a cache size of the idle shared cache is greater than the adjustment size, where the first cache benefit change corresponds to the target cache partition, and the second cache benefit change corresponds to a cache partition of all the other tenants in the at least two tenants; or

release a cache from the target cache partition when a third cache benefit change is less than a fourth cache benefit change and a cache size of the idle shared cache is less than the adjustment size, where the third cache benefit change corresponds to the target cache partition, and the fourth cache benefit change corresponds to a cache partition of all the other tenants in the at least two tenants.

In an optional implementation, optional content of a cache benefit is further provided and is specifically as follows: The cache benefit includes:

a benefit in quality of service, or a benefit by a service level agreement due to the benefit in quality of service.

In an optional implementation, specific examples of the benefit in quality of service, and the benefit by the service level agreement due to the benefit in quality of service are further provided as follows:

The benefit in quality of service includes a benefit by a cache hit ratio and/or a benefit by a cache read response time.

The benefit by the service level agreement due to the benefit in quality of service includes a benefit due to a penalty of the service level agreement due to a change in quality of service.

In an optional implementation, as shown in FIG. 4, the cache allocation apparatus further includes:

a request receiving unit 403, configured to receive a subscription request from the target tenant;

a data recording unit 404, configured to record subscription data of the target tenant, where the subscription data includes the service level agreement; and a partition creation unit 405, configured to create the target cache partition for the target tenant.

In an optional implementation, a specific implementation solution of analyzing the monitoring record is further provided as follows: The cache adjustment unit 402 includes:

an analysis subunit 4021, configured to analyze the monitoring record based on a fitting function that includes an association among the adjustment size of the target cache partition, the cache size of the target cache partition, a usage amount of the target cache partition, a quantity of online users of the tenant, and a cache hit ratio of the target cache partition.

Based on the fitting function used to analyze the monitoring record in the foregoing embodiment, this embodiment further refines content of the fitting function as follows:

The analysis subunit 4021 is configured to calculate the cache hit ratio based on the following formula:

$${Hiti}^{′} = Log \frac{Δ M * ( 1 / Ni ) * Pi * ( 1 / Ui )}{{hit}_{Lasti}} ,$$

where

the target tenant is an i^{th} tenant, represents a cache hit ratio of the i^{th} tenant, Ni represents a quantity of online users defined in the service level agreement for the i^{th} tenant, hit^{Lasti} represents a cache hit ratio after latest adjustment of a cache partition of the i^{th} tenant, Pi represents a cache size of the cache partition of the it^{th} tenant, Ui represents a cache size actually used in the cache partition of the i^{th} tenant, and represents an adjustment size of the cache partition of the r tenant.

In an optional implementation, a manner of calculating the adjustment size is further provided, and the cache adjustment unit 402 includes:

a calculation subunit 4022, configured to calculate the adjustment size of the target cache partition based on a fitting function that includes an association among a latest adjustment size of the target cache partition, a cache hit ratio after latest adjustment, a cache hit ratio before the latest adjustment, the quantity of online users of the tenant, a cache utilization rate of the target cache partition, and a total cache size of all tenants,

Based on the implementation solution of calculating the adjustment size in the foregoing embodiment, this embodiment further refines the formula used for calculation as follows: The calculation subunit 4022 is configured to calculate the adjustment size of the target cache partition based on the following formula:

$$Δ M = \vert Δ {M}_{lasti} \vert * sin ( arch tan ( \frac{{hit}_{Lasti} - {hit}_{Lasti - 1}}{\vert Δ {M}_{lasti} \vert} ) ) * ( 1 + Ui ) * ( 1 + \frac{Ni}{{\sum }_{i = 0}^{tenantList \cdot size} Ni} ) ,$$

where

ΔM represents the adjustment size of the cache partition of the i^{th} tenant, ΔMₗₐₛₜᵢ represents a cache size of the latest adjustment of the cache partition of the i^{th} tenant, ΔMₗₐₛₜᵢ represents the cache hit ratio after the latest adjustment of the cache partition of the i^{th} tenant, hit_{Lasti-1} represents a cache hit ratio before the latest adjustment of the cache partition, Ni represents the quantity of online users defined in the service level agreement for the i^{th} tenant, Ui represents a cache utilization rate of the cache partition of the tenant, archtan represents a tangent autoregressive conditional heteroscedasticity model, sin represents a sine function, and

$${\sum }_{i = 0}^{tenantList \cdot size} Ni$$

represents the total cache size of cache partitions of all the tenants.

In an optional implementation, to further reduce unnecessary calculation workload, a case in which a cache size of a cache partition does not need to be adjusted is screened out in this embodiment of this application, specifically as follows: The cache adjustment unit 402 is further configured to: when determining that an average cache read response time of a user of the target tenant is less than or equal to a cache read response time specified in the service level agreement of the target tenant, and the quantity of online users of the target tenant is less than or equal to a quantity of online users specified in the service level agreement, determine that the adjustment size of the target cache partition is zero.

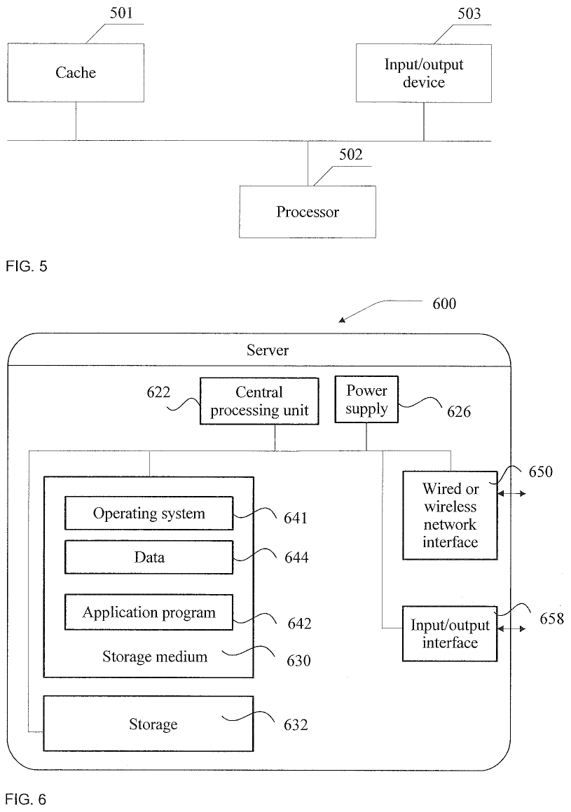

FIG. 5 is a cache allocation apparatus according to an embodiment of this application. The cache allocation apparatus includes: a cache 501, a processor 502, and an input/output device 503. The cache 501 may be included in a storage or integrated into the processor 502. The cache 501 includes a cache partition of a tenant. The storage may store executable code, and the processor 502 has a function of reading the executable code or implementing, by using hardware, the methods provided in the embodiments of this application. Functions of the methods in the embodiments are not described herein. The cache 501, the processor 502, and the input/output device 503 may be connected to each other by using a bus.

If the cache 501 is included in the storage, the storage includes but is not limited to a random access memory (Random Access Memory, RAM), a read-only memory (Read-Only Memory, ROM), an erasable programmable read only memory (Erasable Programmable Read Only Memory, EPROM), or a compact disc read-only memory (Compact Disc Read-Only Memory, CD-ROM). The storage may be configured to store a related instruction and data. The input/output device 503 is configured to receive and send data.

The processor 502 may be one or more central processing units (Central Processing Unit, CPU). When the processor 502 is one CPU, the CPU may be a single-core CPU, or may be a multi core CPU.

It may be understood that if the processor 502 completes all the foregoing method processes, the processor 502 may implement functions of tenant cache read/write API 131, the tenant cache partition monitor 132, the tenant cache partition adjuster 133, and the tenant cache partitioner 134 in the system 100 shown in FIG. 1.

FIG. 6 is a schematic structural diagram of a server 600 according to an embodiment of this application. The server 600 may differ greatly because of different configurations or performance, and may include one or more central processing units (central processing units, CPU) 622 (for example, one or more processors), a storage 632, and one or more storage media 630 (for example, one or more mass storage devices) that store an application program 642 or data 644. Cache space and a cache space-based cache partition may be integrated in the storage 632. The storage 632 and the storage medium 630 may perform temporary storage or permanent storage. The program stored in the storage medium 630 may include one or more modules (not shown in the figure), and each module may include a series of instructions for performing operations on the server. Still further, the central processing unit 622 may be configured to: communicate with the storage medium 630, and execute a series of instructions in the storage medium 630 to perform operations on the server 600.

The server 600 may further include one or more power supplies 626, one or more wired or wireless network interfaces 650, one or more input/output interfaces 658, and/or one or more operating systems 641 such as Windows Server™, Mac OS X™, Unix™, Linux™, and FreeBSD™.

In the foregoing embodiments, the steps performed by the cache allocation apparatus may be based on the server structure shown in FIG. 6. The server may be corresponding to functions of the SaaS application server 120 and the cache management server 130 in the system 100 shown in FIG. 1.

It should be noted that implementation of each operation may be corresponding to a corresponding description in the foregoing embodiment. Therefore, details are not described in this embodiment.

A person of ordinary skill in the art may understand that all or some of the processes of the methods in the embodiments may be implemented by a computer program instructing related hardware. The program may be stored in a computer readable storage medium. When the program runs, the processes of the methods in the embodiments are performed. The foregoing storage medium includes any medium that can store program code, such as a ROM, a random access memory RAM, a magnetic disk, or an optical disc.

1. A cache allocation method, wherein the cache allocation method is applied to software as a service (SaaS) that serves at least two tenants, the at least two tenants comprise a target tenant, a cache partition of the target tenant is a target cache partition, and the method comprises:
obtaining a first cache size and a monitoring record of the target tenant, wherein the monitoring record comprises a correspondence between an adjustment size and a cache benefit change, and the first cache size is a current cache size of the target cache partition; and
analyzing the monitoring record, and adjusting, based on the monitoring record, the first cache size to a second cache size when determining that adjustment of the first cache size to the second cache size meets a cache benefit target.

2. The method according to claim 1, wherein the adjusting the first cache size to a second cache size when determining that adjustment of the first cache size to the second cache size meets the cache benefit target comprises:
allocating a cache of an adjustment size from an idle shared cache to the target cache partition when a first cache benefit change is greater than a second cache benefit change and a cache size of the idle shared cache is greater than the adjustment size, wherein the first cache benefit change corresponds to the target cache partition, and the second cache benefit change corresponds to a cache partition of all the other tenants in the at least two tenants; or
releasing a cache from the target cache partition when a third cache benefit change is less than a fourth cache benefit change and a cache size of the idle shared cache is less than the adjustment size, wherein the third cache benefit change corresponds to the target cache partition, and the fourth cache benefit change corresponds to a the cache partition of all the other tenants in the at least two tenants;
wherein the adjustment size is the difference between the second cache size and the first cache size.

3. The method according to claim 1, wherein a cache benefit comprises:
a benefit by quality of service, or a benefit by a service level agreement due to the benefit in quality of service.

4. The method according to claim 3, wherein the benefit by quality of service comprises a benefit by a cache hit ratio and/or a benefit by a cache read response time; and
the benefit by the service level agreement due to the benefit by quality of service comprises a benefit due to a penalty of the service level agreement due to a change in quality of service.

5. The method according to claim 4, wherein before the obtaining a first cache size, the method further comprises:
receiving a subscription request from the target tenant, recording subscription data in the subscription request of the target tenant, and creating the target cache partition for the target tenant based on the subscription data, wherein the subscription data comprises the service level agreement.

6. The method according to claim 1, wherein the analyzing the monitoring record comprises:
analyzing the monitoring record based on a fitting function that comprises an association among the adjustment size of the target cache partition, the cache size of the target cache partition, a usage amount of the target cache partition, a quantity of online users of the target tenant, and a cache hit ratio of the target cache partition.

7. The method according to claim 6, wherein the analyzing the monitoring record comprises:
calculating the cache hit ratio based on the following formula:
$${Hiti}^{′} = Log \frac{Δ M * ( 1 / Ni ) * Pi * ( 1 / Ui )}{{hit}_{Lasti}} ,$$
wherein the target tenant is an i^{th} tenant, Hiti′ represents a cache hit ratio of the tenant, Ni represents a quantity of online users defined in the service level agreement for the i^{th} tenant, hit^{Lasti} represents a cache hit ratio after a latest adjustment of a cache partition of the i^{th} tenant, Pi represents a cache size of the cache partition of the it^{th} tenant, Ui represents a cache size actually used in the cache partition of the i^{th} tenant, and ΔM represents an adjustment size of the cache partition of the i^{th} tenant.

8. The method according to claim 1, wherein the method further comprises:
calculating the adjustment size of the target cache partition based on a fitting function that
comprises an association among a latest adjustment size of the target cache partition, a cache hit ratio after latest adjustment, a cache hit ratio before the latest adjustment, the quantity of online users of the tenant, a cache utilization rate of the target cache partition, and a total cache size of all tenants.

9. The method according to claim 8, wherein the calculating the adjustment size of the target cache partition based on a fitting function comprises:
calculating the adjustment size of the target cache partition based on the following formula:
$$Δ M = \vert Δ {M}_{lasti} \vert * sin ( arch tan ( \frac{{hit}_{Lasti} - {hit}_{Lasti - 1}}{\vert Δ {M}_{lasti} \vert} ) ) * ( 1 + Ui ) * ( 1 + \frac{Ni}{{\sum }_{i = 0}^{tenantList \cdot size} Ni} ) ,$$
wherein
ΔM represents the adjustment size of the cache partition of the i^{th} tenant, ΔMₗₐₛₜᵢ represents a cache size of the latest adjustment of the cache partition of the i^{th} tenant, hit_{Lasti} represents the cache hit ratio after the latest adjustment of the cache partition of the i^{th} tenant, hit_{Lasti-1} represents a cache hit ratio before the latest adjustment of the cache partition, Ni represents the quantity of online users defined in the-a service level agreement for the tenant, Ui represents a cache utilization rate of the cache partition of the i^{th} tenant, archtan represents a tangent autoregressive conditional heteroscedasticity model, sin represents a sine function, and
$${\sum }_{i = 0}^{tenantList \cdot size} Ni$$
represents the total cache size of cache partitions of all the tenants.

10. The method according to claim 9, wherein before the calculating the adjustment size of the target cache partition, the method further comprises:
when determining that an average cache read response time of a user of the target tenant is less than or equal to a cache read response time defined in the service level agreement of the target tenant, and the quantity of online users of the target tenant is less than or equal to a quantity of online users defined in the service level agreement, determining that the adjustment size of the target cache partition is zero.

11. A cache allocation apparatus, wherein the cache allocation apparatus is applied to software as a service (SaaS) that serves at least two tenants, the at least two tenants comprise a target tenant, a cache partition of the target tenant is a target cache partition, and the cache allocation apparatus comprises:
at least one processor;
a non-transitory computer-readable storage medium coupled to the at least one processor and storing programming instructions for execution by the at least one processor, wherein the programming instructions instruct the at least one processor to:
obtain a first cache size and a monitoring record of the target tenant, wherein the monitoring record comprises a correspondence between an adjustment size and a cache benefit change, and the first cache size is a current cache size of the target cache partition; and
analyze the monitoring record, and adjust the first cache size to a second cache size when determining that adjustment of the first cache size to the second cache size meets a cache benefit target.

12. The cache allocation apparatus according to claim 11, wherein the programming instructions instruct the at least one processor to:
allocate a cache of the adjustment size from an idle shared cache to the target cache partition when a first cache benefit change is greater than a second cache benefit change and a cache size of the idle shared cache is greater than the adjustment size, wherein the first cache benefit change corresponds to the target cache partition, and the second cache benefit change corresponds to a cache partition of all the other tenants in the at least two tenants; or
release a cache from the target cache partition when a third cache benefit change is less than a fourth cache benefit change and a cache size of the idle shared cache is less than the adjustment size, wherein the third cache benefit change is corresponds to the target cache partition, and the fourth cache benefit change corresponds to a cache partition of all the other tenants in the at least two tenants.

13. The cache allocation apparatus according to claim 11, wherein a cache benefit comprises:
a benefit by quality of service, or a benefit by a service level agreement due to the benefit by quality of service.

14. The cache allocation apparatus according to claim 13, wherein
the benefit by quality of service comprises a benefit by a cache hit ratio and/or a benefit by a cache read response time; and
the benefit by the service level agreement due to the benefit by quality of service comprises a benefit due to a penalty of the service level agreement due to a change in quality of service,

15. The cache allocation apparatus according to claim 14, wherein the programming instructions instruct the at least one processor to:
receive a subscription request from the target tenant;
record subscription data of the target tenant; and
create the target cache partition for the target tenant, wherein the subscription data comprises the service level agreement.

16. The cache allocation apparatus according to claim 11, wherein the programming instructions instruct the at least one processor to:
analyze the monitoring record based on a fitting function that comprises an association among the adjustment size of the target cache partition, the cache size of the target cache partition, a usage amount of the target cache partition, a quantity of online users of the tenant, and a cache hit ratio of the target cache partition.

17. The cache allocation apparatus according to claim 16, wherein the programming instructions instruct the at least one processor to: calculate the cache hit ratio based on the following formula:
$${Hiti}^{′} = Log \frac{Δ M * ( 1 / Ni ) * Pi * ( 1 / Ui )}{{hit}_{Lasti}} ,$$
wherein
the target tenant is an i^{th} tenant, Hiti′ represents a cache hit ratio of the i^{th} tenant, Ni represents a quantity of online users defined in the-a service level agreement for the tenant, hit_{Lasti} represents a cache hit ratio after latest adjustment of a cache partition of the i^{th} tenant, Pi represents a cache size of the cache partition of the i^{th} tenant, Ui represents a cache size actually used in the cache partition of the i^{th} tenant, and ΔM represents an adjustment size of the cache partition of the i^{th} tenant.

18. The cache allocation apparatus according to claim 11, wherein the programming instructions instruct the at least one processor to:
calculate the adjustment size of the target cache partition based on a fitting function that comprises an association among a latest adjustment size of the target cache partition, a cache hit ratio after latest adjustment, a cache hit ratio before the latest adjustment, the quantity of online users of the tenant, a cache utilization rate of the target cache partition, and a total cache size of all tenants.

19. The cache allocation apparatus according to claim 18, wherein the programming instructions instruct the at least one processor to:
calculate the adjustment size of the target cache partition based on the following formula:
$$Δ M = \vert Δ {M}_{lasti} \vert * sin ( arch tan ( \frac{{hit}_{Lasti} - {hit}_{Lasti - 1}}{\vert Δ {M}_{lasti} \vert} ) ) * ( 1 + Ui ) * ( 1 + \frac{Ni}{{\sum }_{i = 0}^{tenantList \cdot size} Ni} ) ,$$
wherein
ΔM represents the adjustment size of the cache partition of the i^{th} tenant, ΔMₗₐₛₜᵢ represents a cache size of the latest adjustment of the cache partition of the i^{th} tenant, hit^{Lasti} represents the cache hit ratio after the latest adjustment of the cache partition of the i^{th} tenant, hit_{Lasti-1} represents a cache hit ratio before the latest adjustment of the cache partition, Ni represents the quantity of online users defined in the-a service level agreement for the i^{th} tenant, Ui represents a cache utilization rate of the cache partition of the tenant, archtan represents a tangent autoregressive conditional heteroscedasticity model, sin represents a sine function, and
$${\sum }_{i = 0}^{tenantList \cdot size} Ni$$
represents the total cache size of cache partitions of all the tenants.

20. The cache allocation apparatus according to claim 19, wherein the programming instructions instruct the at least one processor to:
determine, when determining that an average cache read response time of a user of the target tenant is less than or equal to a cache read response time specified in the service level agreement of the target tenant, and the quantity of online users of the target tenant is less than or equal to a quantity of online users specified in the service level agreement, that the adjustment size of the target cache partition is zero.
